(19) United States
(12) Patent Application Publication
(10) Pub. No.: US 2017/0050274 A1
(43) Pub. Date: Feb. 23, 2017

(54) METHOD FOR REMANUFACTURING A DAMAGED SURFACE OF A COMPONENT

(71) Applicant: Caterpillar Inc., Peoria, IL (US)

(72) Inventors: Kyle Corn, Flat Rock, IN (US); James M. Doughrity, Franklin, IN (US)

(73) Assignee: Caterpillar Inc., Peoria, IL (US)

(21) Appl. No.: 15/344,816

(22) Filed: Nov. 7, 2016

(51) Int. Cl. B23P 6/00; F01P 5/10

(52) U.S. Cl. CPC B23P 6/00; F01P 5/10

(57) ABSTRACT

A method for remanufacturing an internal surface of a pump is provided. The internal surface includes a damaged portion thereon. The method includes machining at least a section of the internal surface to remove at least a section of the damaged portion, The machined surface includes a first geometrical feature thereon. The method includes providing an insert having a first surface. The first surface includes a second geometrical feature thereon. The second geometrical feature corresponds to the first geometrical feature of the machined surface. The method also includes aligning the first geometrical feature with respect to the second geometrical feature. The method further includes removably affixing the insert on the machined surface of the pump.

### TECHNICAL FIELD

The present disclosure relates to a method for remanufacturing a damaged surface of a component. More particularly, the present disclosure relates to the method for remanufacturing a damaged surface of a pump associated with an engine.

### BACKGROUND

Generally, engines include a casing mounted thereon associated with a pump, such as a water pump of the engine. During operation, an internal surface of the casing may be damaged due to various reasons, such as friction and cavitation. In such a situation, the damaged casing may be replaced with a new casing, in turn increasing maintenance and lifecycle cost of the engine.

In many situations, the casing for the pump may be a part of a larger engine casing which may function as a casing for various other parts of the engine including the pump. In such a situation, a damaged portion of the casing associated with the pump may be remanufactured using conventional repair methods. The conventional repair methods may include repetitive machining and welding of the damaged portion in order to rebuild the damaged portion to original design specifications, This may lead to increased repair time leading to increased machine downtime, increased costs, and so on. Hence, there is a need for an improved remanufacturing method for the damaged surface of the pump.

U.S. Pat. No. 9,206,811 describes a remanufactured pump having a casing and a pumping mechanism positioned within the casing. The pump includes a rotatable pump shaft and an impeller mounted upon the pump shaft and rotatable within a pumping chamber in the casing. A first insert is held fast within a first bore in the casing, and a second insert is held fast within a second bore in the casing, each via an interference fit. Sealing mechanisms are positioned within the first and second inserts to form a first seal about the pump shaft to prevent leakage of a working fluid from the pumping chamber, and a second seal about the pump shaft to prevent leakage of a lubricating fluid from a bearing chamber in the casing.

### SUMMARY OF THE DISCLOSURE

In an aspect of the present disclosure, a method for remanufacturing an internal surface of a pump is provided. The internal surface includes a damaged portion thereon. The method includes machining at least a section of the internal surface to remove at least a section of the damaged portion. The machined surface includes a first geometrical feature thereon. The method includes providing an insert having a first surface. The first surface includes a second geometrical feature thereon. The second geometrical feature corresponds to the first geometrical feature of the machined surface. The method also includes aligning the first geometrical feature with respect to the second geometrical feature. The method further includes removably affixing the insert on the machined surface of the pump.

Other features and aspects of this disclosure will be apparent from the following description and the accompanying drawings.

### BRIEF DESCRIPTION OF THE DRAWINGS

FIG. 1 is a front perspective view of a portion of an engine, according to one embodiment of the present disclosure;

FIG. 2 is a front view of an internal surface of a pump having a damaged portion thereon, according to one embodiment of the present disclosure;

FIG. 3 is a front view of the internal surface of the pump of FIG. 2 after machining thereof, according to one embodiment of the present disclosure;

FIG. 4 is a front view of the internal surface of the pump of FIG. 3 with a number of holes drilled therein, according to one embodiment of the present disclosure;

FIG. 5 is a cross sectional view of the internal surface of the pump of FIG. 4 along a section A-A′, according to one embodiment of the present disclosure;

FIG. 6 is a front view of a fixture assembled on the internal surface of the pump of FIG, 3, according to one embodiment of the present disclosure;

FIG. 7A is a front view of an insert, according to one embodiment of the present disclosure;

FIG. 7B is a cross sectional view of the insert of FIG. 7A along a section B-B′, according to one embodiment of the present disclosure;

FIG. 8 is a cross sectional view of the insert of FIGS. 7A and 7B positioned on the internal surface of the pump of FIG. 5, according to one embodiment of the present disclosure;

FIG. 9 is a front view of the internal surface of the pump of FIG. 4 with the insert of FIGS. 7A and 7B being assembled thereon, according to one embodiment of the present disclosure; and

FIG. 10 is a flowchart of a method of remanufacturing the internal surface of the pump of FIG. 2, according to one embodiment of the present disclosure.

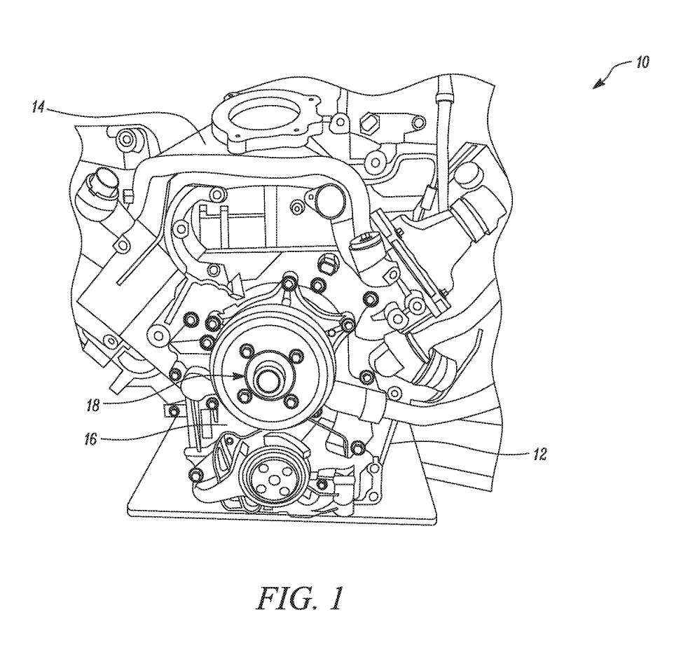

### DETAILED DESCRIPTION

Wherever possible, the same reference numbers will be used throughout the drawings to refer to the same or the like parts, Referring to FIG. 1, a portion of an exemplary engine 10 is illustrated. The engine 10 is an internal combustion engine powered by a fuel such as gasoline, diesel, natural gas, and so on, or a combination thereof The engine 10 may be used for applications including, but not limited to, power generation, transportation, construction, agriculture, forestry, aviation, marine, material handling, and waste management.

The engine 10 includes an engine block 12 and a cylinder head 14 mounted on the engine block 12. The engine 10 also includes various other components (not shown) such as a crankcase, a fuel delivery system, an air system, a cooling system, a turbocharger, an exhaust gas recirculation system, an exhaust aftertreatment system, and so on. Also, the engine 10 may be of any size including a number of cylinders (not shown) arranged in any configuration such as inline, radial, “V”, and so on.

The engine 10 includes a casing 16 mounted on a front side thereof. The casing 16 encloses one or more components of the engine 10, such as a pump 18. In the illustrated embodiment, the pump 18 is a water pump adapted to provide water through a cooling circuit (not shown) of the engine 10. In other embodiments, the pump 18 may be any other pump, such as a coolant pump, an oil pump, and so on, associated with the engine 10.

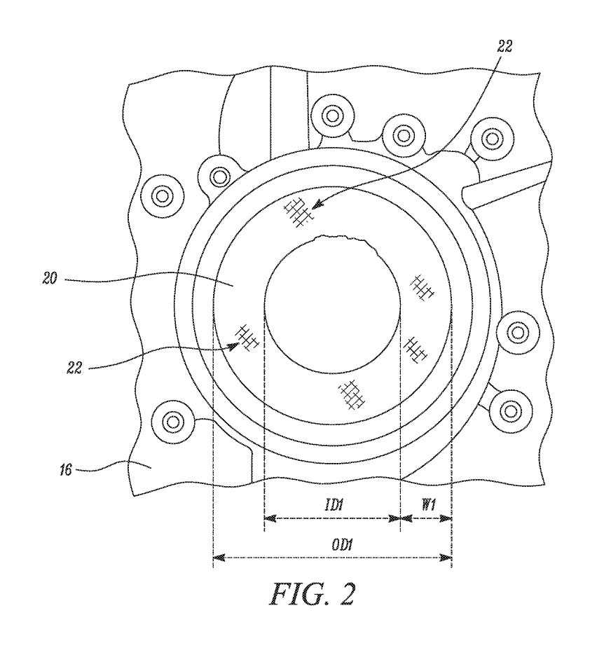

Referring to FIG. 2, an internal surface 20 of the casing 16 associated with the pump 18 is illustrated. The “internal surface 20” may be interchangeably referred to as the “surface 20”. Also, for the purpose of clarity, internal components of the pump 18, such as an impeller, seals, shaft, and so on, have been omitted. In the illustrated embodiment, the surface 20 includes a ring like configuration. Accordingly, the surface 20 includes an inner diameter “ID1” and an outer diameter “OD1”. The surface 20 also includes a width “W1” defined between the inner diameter “ID1” and the outer diameter “OD1”. Accordingly, the width “W1” equals to half of the distance between the outer diameter “OD1” and the inner diameter “ID1”, that is [(OD1−ID1)/2].

In other embodiments, the surface 20 may include any other configuration, such as a plate like configuration. It should be noted that the configuration of the surface 20 described herein is merely exemplary and may vary based on application requirements. During operation, the surface 20 is exposed to wear and tear due to variety of factors including, but not limited to, friction and cavitation. As a result, the surface 20 undergoes material erosion in turn forming damaged portions 22 thereon (as shown in the FIG. 2).

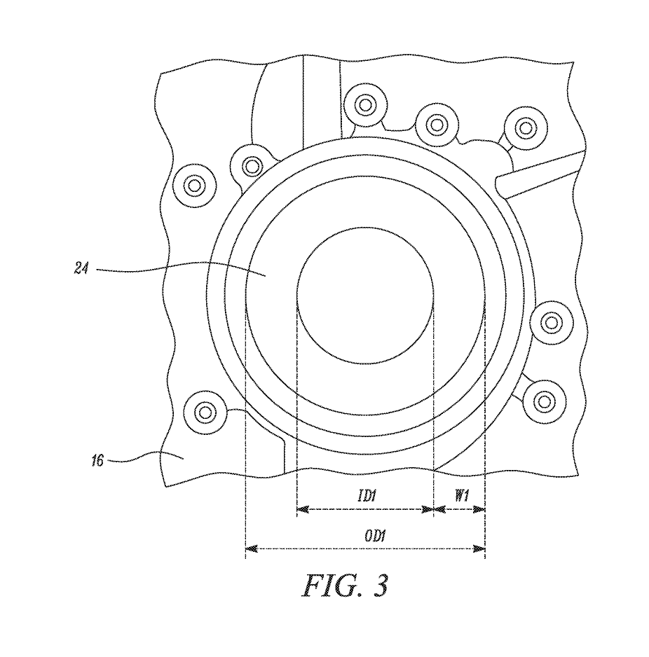

Referring to FIG. 3, a portion of the surface 20 is machined in order to remove the damaged portion 22. More specifically, a top layer of the surface 20 is machined in order to remove the damaged portion 22 in turn forming a machined surface 24. It should be noted that the surface 20 may be machined in order to maximize removal of the damaged portion 22 while minimizing removal of the surface 20. The surface 20 may be machined using any known material removal method known in the art, such as grinding, polishing, cutting, scraping, and so on.

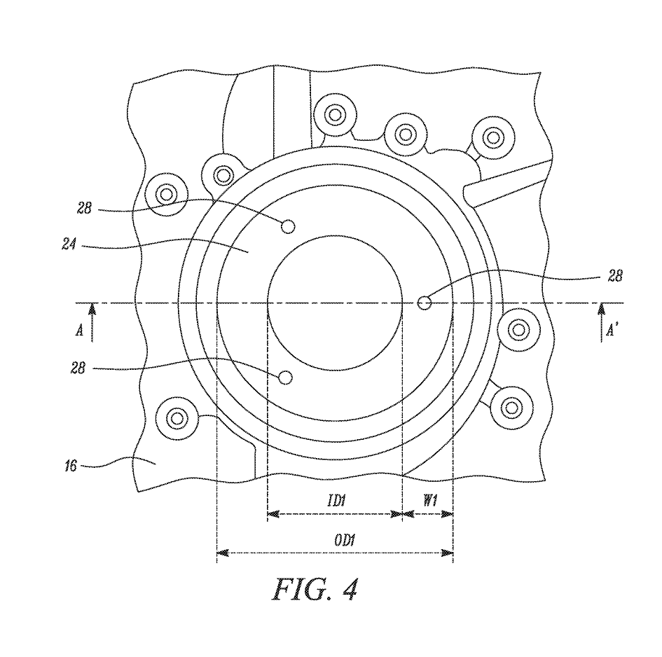

Referring to FIG. 4, the machined surface 24 includes a first set of holes 28 provided thereon. In the illustrated embodiment, the first set of holes 28 include three holes provided on the machined surface 24. Each of the first set of holes 28 are provided spaced apart with respect to one another. In other embodiments, the first set of holes 28 may include a single or multiple holes provided on the machined surface 24 based on application requirements.

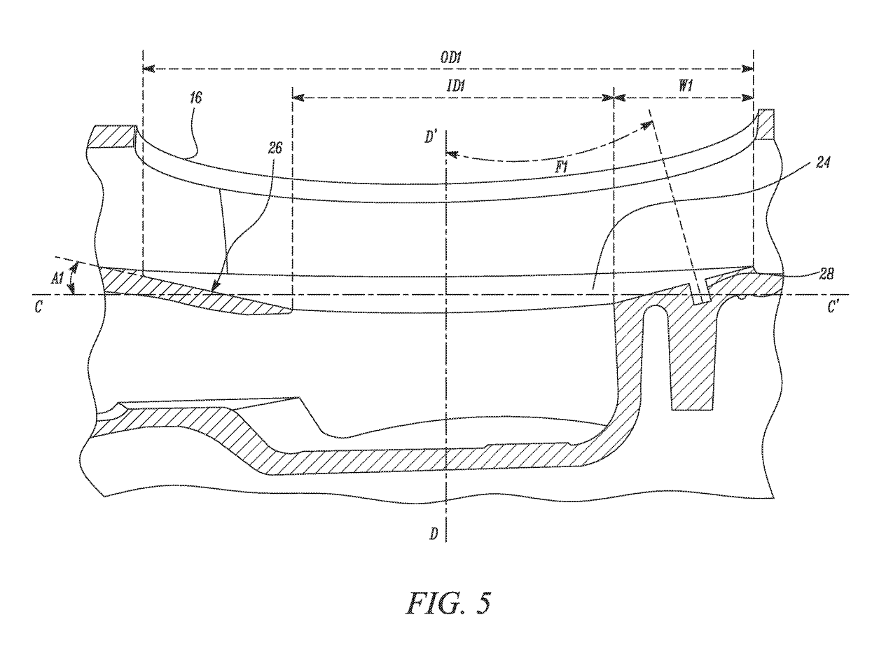

Referring to FIG. 5, a cross sectional view of the machined surface 24 along a section A-A′ (shown in FIG. 4) is illustrated. The machined surface 24 includes a first geometrical feature provided thereon, The first geometrical feature is provided on the machined surface 24 during machining of the surface 20. In the illustrated embodiment, the first geometrical feature includes a first slope 26 with respect to a horizontal plane along an axis C-C′ of the machined surface 24.

The first slope 26 defines an angle “A1” with respect to the horizontal plane along the axis C-C′. The angle “A1” may include values between 10° and 20° and may vary based on application requirements. In other embodiments, the first geometrical feature may include any other configuration including, but not limited to, a stepped configuration, a grooved configuration, a ribbed configuration, and so on, without limiting the scope of the disclosure.

Further, in the illustrated embodiment, the first set of holes 28 is inclined at a first angle “F1” with respect to an axis D-D′ of the machined surface 24. The first angle “F1” may include values between 10° and 15° and may vary based on application requirements. As such, in some embodiments, the first angle “F1” may include values between 0° and 90° based on application requirements. It should be noted that a pictorial representation of the first angle “F1” with respect to the axis D-D′ is not to scale and is deviated for the purpose of explanation within the illustrated figures.

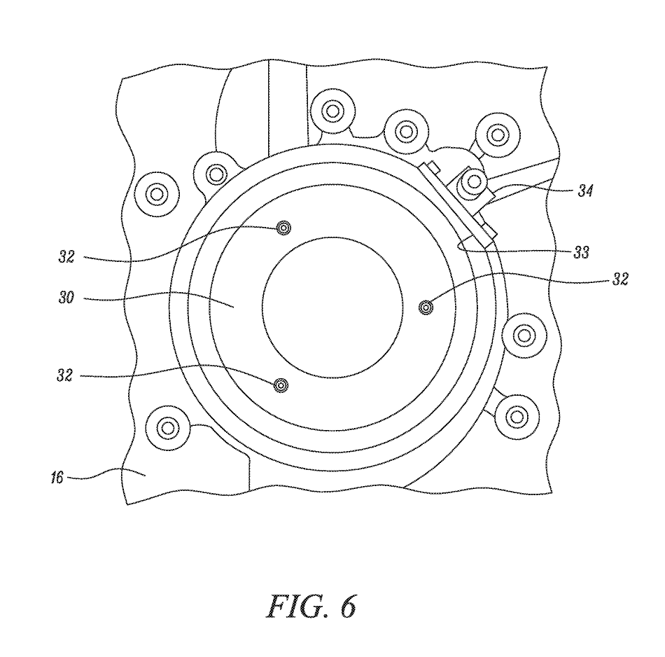

The first set of holes 28 may be provided on the machined surface 24 using any conventional drilling methods. For example, referring to FIG. 6, a fixture 30 is provided in order to drill the first set of holes 28 on the machined surface 24. The fixture 30 includes a bowl shaped configuration adapted to be positioned on the machined surface 24. The fixture 30 provides a reference for drilling the first set of holes 28 at a required location and at a required inclination on the machined surface 24. Accordingly, the fixture 30 includes a configuration similar to a configuration of the machined surface 24. More specifically, the fixture 30 includes reference holes 32 each having a location and an inclination corresponding to a location and an inclination of the respective first set of holes 28 on the machined surface 24.

The fixture 30 is aligned and removably affixed on the machined surface 24 via a locking bracket 34. More specifically, the fixture 30 is aligned in a manner such that the locking bracket 34 is adjacent and in contact with an aligning surface 33 provided on the fixture 30. The first set of holes 28 are then drilled on the machined surface 24 via the reference holes 32. After drilling of the first set of holes 28, the fixture 30 and the locking bracket 34 may then be disassembled and separated from the machined surface 24. It should be noted that the fixture 30 described herein is merely exemplary and that the first set of holes 28 may be provided on the machined surface 24 using any other known method. For example, the first set of holes 28 may be provided using any automated, manual, or semi-automated method such as a Computer Numeric Control (CNC) machine, a multi axis drilling machine, a robotic drill arm, and so on, without limiting the scope of the disclosure.

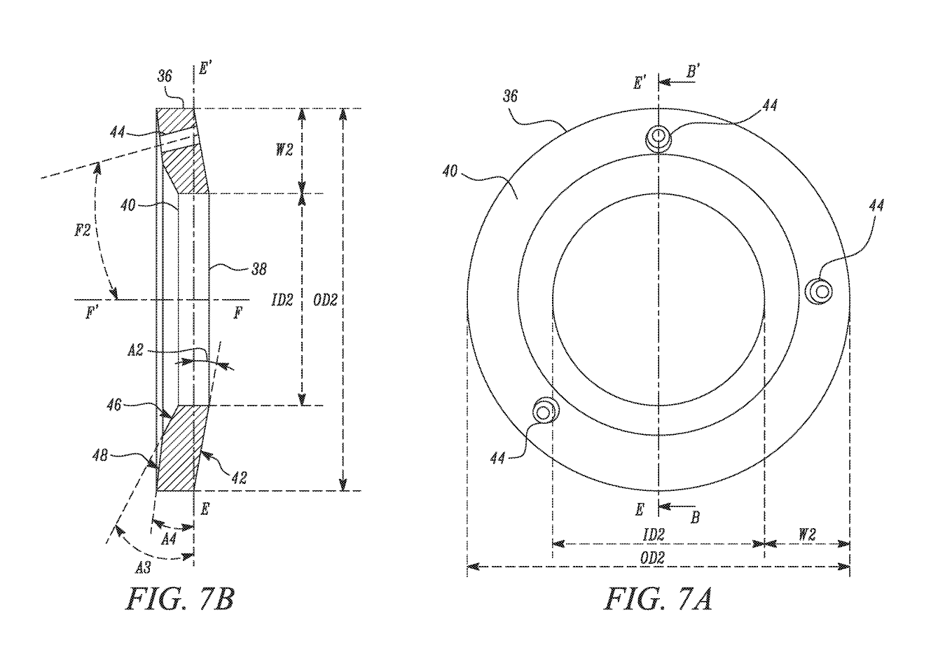

Referring to FIGS. 7A and 7B, different views of an insert 36 for the machined surface 24 is illustrated. The insert 36 includes an overall configuration similar to the overall configuration of the surface 20. More specifically, the insert 36 includes a ring like configuration. Accordingly, the insert 36 includes an inner diameter “ID2” approximately equal to the inner diameter “ID1” of the surface 20, The insert 36 also includes an outer diameter “OD2” approximately equal to the outer diameter “OD1” of the surface 20. The insert 36 further includes a width “W2” defined between the inner diameter “ID2” and the outer diameter “OD2”. Accordingly, the width “W2” equals to half of the distance between the outer diameter “OD2” and the inner diameter “ID2”, that is [(OD2−ID2)/2]. The width “W2” is approximately equal to the width “W1” of the surface 20.

The insert 36 includes a first surface 38 and a second surface 40. The second surface 40 is disposed opposite with respect to the first surface 38. The first surface 38 includes a second geometrical feature provided thereon. The second geometrical feature corresponds to the first geometrical feature of the machined surface 24. In the illustrated embodiment, the second geometrical feature includes a second slope 42 with respect to a horizontal plane along an axis E-E′ of the insert 36.

The second slope 42 defines an angle “A2” with respect to the horizontal plane along the axis E-E′. The second slope 42 is equal to the first slope 26. Accordingly, the angle “A2” is equal to the angle “A1” defined by the first slope 26. The angle “A2” may include values between 10° and 20° and may vary based on application requirements. In other embodiments, the second geometrical feature may include any other configuration including, but not limited to, a stepped configuration, a grooved configuration, a ribbed configuration, and so on, without limiting the scope of the disclosure.

The insert 36 further includes a second set of holes 44 provided therethrough. In the illustrated embodiment, the second set of holes 44 includes three holes provided therethrough. Each of the second set of holes 44 is provided spaced apart with respect to one another, In other embodiments, the insert 36 may include a single or multiple holes provided therethrough based on application requirements. A configuration of each of the second set of holes 44 is similar to a configuration of each of the first set of holes 28 provided through the machined surface 24.

Accordingly, a location of each of the second set of holes 44 provided through the insert 36 corresponds to the location of each of the first set of holes 28 provided through the machined surface 24. Further, in the illustrated embodiment, the second set of holes 44 is inclined at a second angle “F2” with respect to an axis F-F′ of the insert 36. The second angle “F2” is equal to the first angle “F1” of the first set of holes 28 with respect to the axis D-D′. Accordingly, the second angle “F2” may include values between 10° and 15° and may vary based on application requirements. It should be noted that a pictorial representation of the second angle “F2” with respect to the axis F-F′ is not to scale and is deviated for the purpose of explanation within the illustrated figures. In other embodiments, the second set of holes 44 may be provided parallel to the axis F-F′ or normal to the axis E-E′ of the insert 36. The second set of holes 44 may be provided through the machined surface 24 using any conventional drilling methods.

Also, the second surface 40 of the insert 36 includes a third geometrical feature provided thereon. In the illustrated embodiment, the third geometrical feature includes a first inclination 46 with respect to the horizontal axis along the axis E-E′ of the insert 36. The first inclination 46 defines an angle “A3” with respect to the horizontal axis along the axis E-E′. The angle “A3” may include values between 10° and 20° and may vary based on application requirements.

Additionally, the third geometrical feature also includes a second inclination 48 with respect to the horizontal axis along the axis E-E′ of the insert 36. The second inclination 48 is provided adjacent to the first inclination 46. The second inclination 48 defines an angle “A4” with respect to the horizontal axis along the axis E-E′. The angle “A4” may include values between 10° and 20° and may vary based on application requirements. It should be noted that the angle “A3” is greater than the angle “A4” may vary based on application requirements. In other embodiments, the third geometrical feature may include any other configuration including, but not limited to, a single inclination, multiple inclinations, a stepped configuration, a grooved configuration, a ribbed configuration, and so on, without limiting the scope of the disclosure.

It should be noted that the third geometrical feature described herein is merely exemplary and may vary based on application requirements. More specifically, in some embodiments, the third geometrical feature may be omitted. In such a situation, the second surface 40 of the insert 36 may be flat and parallel with respect to the axis E-E′. Also, in the illustrated embodiment, the third geometrical feature, including the first inclination 46 and/or the second inclination 48, is formed on the second surface 40 during manufacturing of the insert 36.

In other embodiments, the insert 36 may be manufactured without the third geometrical feature on the second surface 40. In such a situation, the third geometrical feature may be provided on the second surface 40 after assembly of the insert 36 on the machined surface 24, using any known machining process. In yet other embodiments, a portion of the third geometrical feature may be provided on the second surface 40 during manufacturing of the insert 36 and a remaining portion of the third geometrical feature may be provided on the second surface 40 after assembly of the insert 36 on the machined surface 24.

The insert 36 may be made of any metal or alloy known in the art. The insert 36 may be manufactured using any method known in the art, such as casting, forging, machining, additive manufacturing, and so on. Also, in one situation, the second geometrical feature, the third geometrical feature, and/or the second set of holes 44 may be provided on or through the insert 36 during manufacturing. In another situation, the second geometrical feature, the third geometrical feature, and/or the second set of holes 44 may be provided on or through the insert 36 respectively post manufacturing using suitable machining methods.

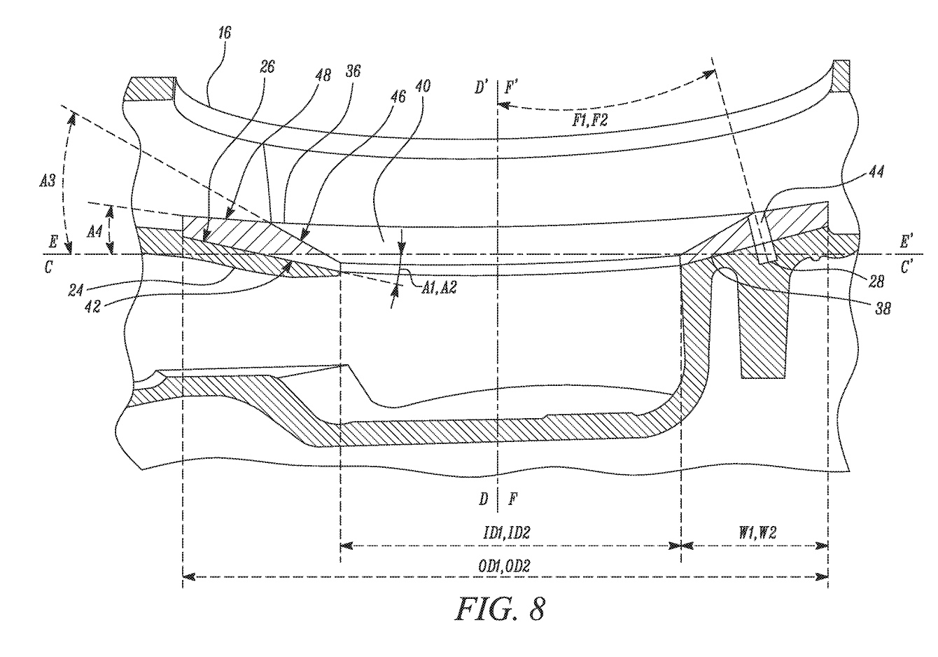

Referring to FIG. 8, during assembly, the insert 36 is positioned on the machined surface 24. The first geometrical feature of the machined surface 24 is aligned with respect to the second geometrical feature of the insert 36. More specifically, the first slope 26 of the machined surface 24 is aligned with respect to the second slope 42 of the insert 36 in a manner such that the first slope 26 is in contact with the second slope 42. Also, the first set of holes 28 of the machined surface 24 are aligned with respect to the second set of holes 44 of the insert 36.

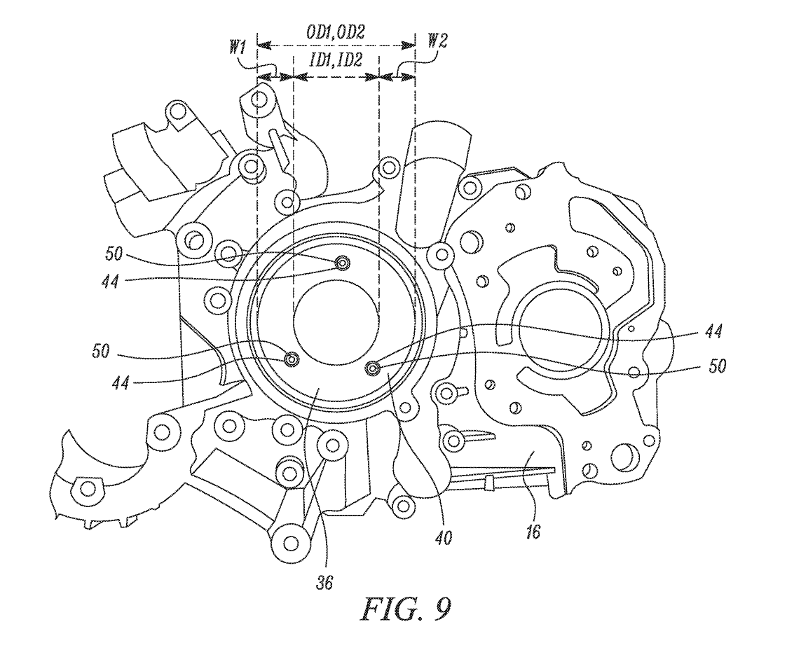

Further, referring to FIG. 9, fastening members 50 are provided in the aligned first set of holes 28 and the second set of holes 44, The fastening members 50 removably affix the insert 36 with respect to the machined surface 24. The fastening members 50 may be any fasteners known in the art, such as bolts, screws, and so on.

### Industrial Applicability

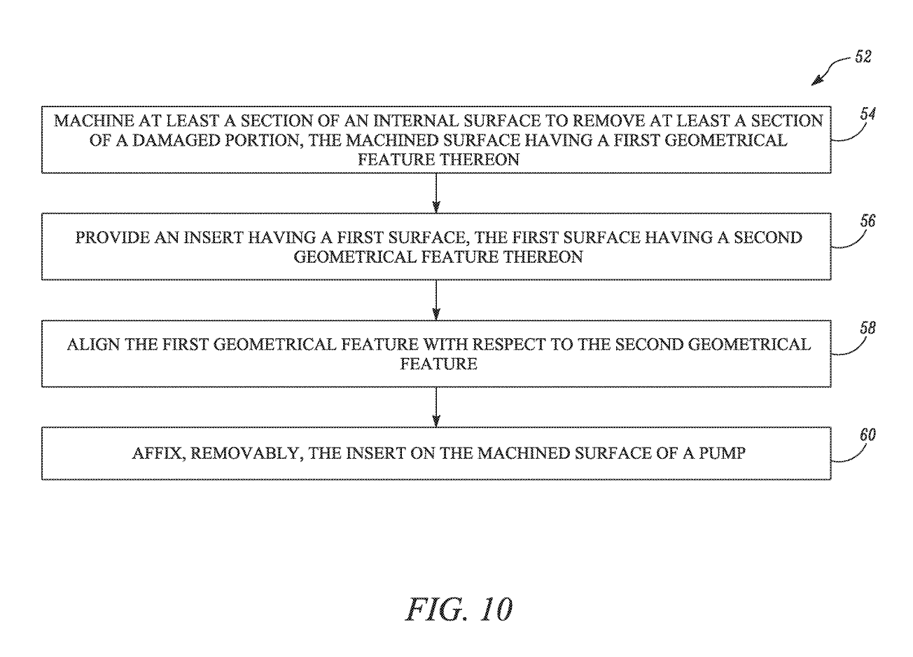

The present disclosure relates to a method 52 of remanufacturing the surface 20 of the pump 18. The surface 20 includes the damaged portion 22 thereon. The damaged portion 22 may be formed on the surface 20 due to variety of factors, such as friction, cavitation, and so on, during operation of the pump 18. Referring to FIG. 10, a flowchart of the method 52 is provided.

At step 54, the surface 20 is machined in order to remove the damaged portion 22. In one embodiment, a section of the surface 20 may be machined in order to remove a section of the damaged portion 22. In another embodiment, complete surface 20 may be machined in order to completely remove the damaged portion 22. During the machining, the first geometrical feature in the form of the first slope 26 is provided on the machined surface 24.

Additionally, one or more first set of holes 28 are provided through the machined surface 24. The first set of holes 28 may be provided using the fixture 30 and/or any other conventional drilling method. At step 56, the insert 36 having the first surface 38 and the second surface 40 is provided. The insert 36 includes the second geometrical feature in the form of the second slope 42 provided on the first surface 38. Also, a number of second set of holes 44 are provided through the insert 36.

At step 58, the first geometrical feature of the machined surface 24 is aligned with respect to the second geometrical feature of the insert 36. More specifically, the first slope 26 is aligned and provided in contact with respect to the second slope 42 of the machined surface 24 and the insert 36 respectively. Also, the first set of holes 28 and the second set of holes 44 of the machined surface 24 and the insert 36 are aligned with respect to one another respectively.

At step 60, the insert 36 is removably affixed with respect to the machined surface 24. Accordingly, the fastening members 50 are provided through the first set of holes 28 and the second set of holes 44 in order to removably affix the insert 36 with respect to the machined surface 24. Additionally, in some embodiments, the second surface 40 of the insert 36 may include the third geometrical feature in the four of the first inclination 46 and the second inclination 48.

It should be noted that the third geometrical feature is merely exemplary and optional, and may vary based on application requirements. In the illustrated embodiment, the third geometrical feature is provided on the second surface 40 of the insert 36 during manufacturing of the insert 36. In other embodiments, the third geometrical feature may be provided on the second surface 40 of the insert 36 after assembly of the insert 36 on the machined surface 24.

The method 52 provides a simple, time effective, and cost effective method of remanufacturing the surface 20 of the pump 18, As such, the casing 16 of the engine 10 having limited damaged portion 22 associated with the pump 18 may be salvaged in turn reducing replacement cost of the complete casing 16. Also, the insert 36 removably affixed on the machined surface 24 during the remanufacturing thereof provides a sacrificial surface 20 for further use of the casing 16 and the pump 18. Accordingly, the insert 36 damaged due to further use of the pump 18 may be easily replaced with a new insert 36 without re-machining the machined surface 24 in turn providing ease of repair and serviceability.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A method for remanufacturing an internal surface of a pump, the internal surface having a damaged portion thereon, the method comprising:
machining at least a section of the internal surface to remove at least a section of the damaged portion, the machined surface having a first geometrical feature thereon;
providing an insert having a first surface, the first surface having a second geometrical feature thereon, the second geometrical feature corresponds to the first geometrical feature of the machined surface;
aligning the first geometrical feature with respect to the second geometrical feature; and
affixing, removably, the insert on the machined surface of the pump.

2. The method of claim 1, wherein removably affixing the insert further includes:
providing a first set of holes through the machined surface of the pump;
providing a second set of holes through the insert;
aligning the first set of holes with respect to the second set of holes; and
providing a fastening member through the first set of holes and the second set of holes.

3. The method of claim 2, wherein:
the first set of holes is inclined at a first angle with respect to an axis of the internal surface of the pump; and
the second set of holes is inclined at a second angle with respect to an axis of the insert, the first angle being equal to the second angle.

4. The method of claim 1, wherein:
the first geometrical feature includes a first slope with respect to a plane of the internal surface of the pump; and
the second geometrical feature includes a second slope with respect to a plane of the insert, the first slope being equal to the second slope.

5. The method of claim 1, wherein the insert further includes a second surface disposed opposing the first surface thereof, the second surface having a third geometrical feature thereon.

6. The method of claim 5, wherein the third geometrical feature includes an angle with respect to an axis of the insert.
